(19) United States
(12) Patent Application Publication
(10) Pub. No.: US 2003/0226009 A1
(43) Pub. Date: Dec. 4, 2003

(54) Data transfer system and data transfer method

(75) Inventors: Yasutoshi Maeda, Kanagawa (JP); Kohshiro Inomata, Kanagawa (JP); Katsuya Mitsutake, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/400,524

(22) Filed: Mar. 28, 2003

(30) Foreign Application Priority Data
Jun. 4, 2002 (JP) 2002-162383

(51) Int. Cl. H04L 9/00

(52) U.S. Cl. 713/150; 713/189

(57) ABSTRACT

A data transfer system for transfer target object data from a data transmission apparatus to a data reception apparatus via transfer paths. The data transmission apparatus judges whether or not encrypting operation for the transfer object data is necessary on the basis of attributes of the transfer paths, encrypts the transfer object data when the encrypting operation for the transfer object data is judged to be necessary, and transmits either the transfer object data or the encrypted transfer object data via the transfer paths to the data reception apparatus. The data reception apparatus receives either the transfer object data or the encrypted transfer object data from the data transmission apparatus; judges whether or not decoding operation for the received transfer object data is necessary, and decodes the received transfer object data when the decoding operation for the received transfer object data is judged to be necessary.

### BACKGROUND OF THE INVENTION

1. Field of the Invention

The present invention is related to a data transfer system and a data transfer method, for performing data transfer operations by judging as to whether or not transfer object data is encrypted in response to such a fact that what sort of network is interposed between a data transmission side and a data reception side, and also related to a program recording medium.

2. Background Art

For instance, data are transferred via a plurality of networks belonging to a plurality of organizations in the Internet, or the like.

In the case that another network belonging to another organization which is different from these organizations is interposed between the data transmission side and the data reception side, there are certain possibilities that data to be transferred should be encrypted so as to secure security.

In this case, when the data are encrypted and the encrypted data is transferred irrespective of the sorts of networks interposed between the transmission side and the reception side, lengthy time is necessarily required for the encrypting process operation, so that a throughput would be lowered.

As a consequence, such a data transfer operation is desired. That is, data may be preferably encrypted and the encrypted data is transferred in response to attributes of networks interposed between a data transmission side and a data reception side.

To solve such a problem, for instance, Japanese Laid-open Patent Application No. 2000-214779 (Publication 1) discloses the method of improving the throughput by employing the original encrypting algorithm, not by using the standard encrypting algorithm.

Also, Japanese Laid-open Patent Application No. 2000-295274 (Publication 2) discloses the method of improving the throughput by employing the dedicated hardware.

However, since the throughput improving method opened in Publication 1 does not follow the standard encrypting algorithm, this throughput improving method is not generally applied to general-purpose methods. Also, since the throughput improving method opened in Publication 2 depends upon the hardware, this throughput improving method cannot be used in a flexible manner with respect to a change in technical specifications.

### SUMMARY OF THE INVENTION

The present invention has been made to solve the above-explained problems of the conventional techniques, and therefore, has an object to provide a data transfer system and a data transfer method, capable of transferring data by judging a security aspect of a network interposed between a data transmission side and a data reception side and by adaptively encrypting the data.

Also, another object of the present invention is to provide a data transfer system and a data transfer method, capable of reducing time required for an encrypting process operation so as to improve a throughput, while data is transferred via a plurality of networks.

[Data Transfer System]

To achieve the objects, the invention provides a data transfer system, including: a data transmission apparatus for transmitting transfer object data; and a data reception apparatus for receiving the transfer object data via one or more transfer paths. The data transmission apparatus includes: an encryption necessity judging unit for judging whether or not encrypting operation for the transfer object data is necessary on the basis of attributes of the one or more transfer paths, an encrypting unit for encrypting the transfer object data when the encryption necessity judging unit judges that the encrypting operation for the transfer object data is necessary, and a data transmitting unit for transmitting either the transfer object data or the encrypted transfer object data via the one or more transfer paths to the data reception apparatus. The data reception apparatus includes: a data receiving unit for receiving either the transfer object data or the encrypted transfer object data from the data transmission apparatus; a decryption necessity judging unit for judging whether or not decoding operation for the received transfer object data is necessary; and a decoding unit for decoding the received transfer object data when the decryption necessity judging unit judges that the decoding operation for the received transfer object data is necessary.

[Data Transmission Apparatus]

The invention also provides a data transmission apparatus for transmitting transfer object data via one or more transfer paths, including: an encryption necessity judging unit for judging whether or not encrypting operation for the transfer object data is necessary on the basis of attributes of the one or more transfer paths; an encrypting unit for encrypting the transfer object data when the encryption necessity judging unit judges that the encrypting operation for the transfer object data is necessary; and a data transmitting unit for transmitting either the transfer object data or the encrypted transfer object data via the one or more transfer paths.

Preferably, the data transmission apparatus belongs to a predetermined organization. The encryption necessity judging unit judges that the encrypting operation for the transfer object data is necessary except when each of the one or more transfer paths belongs to the organization.

Preferably, the data transmission apparatus belongs to a predetermined private network; and the encryption necessity judging unit judges that the encrypting operation for the transfer object data is necessary except when respective transfer path addresses of all of the one or more transfer paths correspond to private addresses of the private network.

Preferably, the encryption necessity judging unit judges that the encrypting operation for the transfer object data is necessary when at least one of transfer path addresses of each of the one or more transfer path is different from the other and when at least one of domain names of each of the one or more transfer path is different from the other.

Preferably, the encryption necessity judging unit has a table on which either one or both of transfer path addresses and respective domain names thereof are listed, the transfer path addresses belonging to transmission paths between the data transmission apparatus and a predetermined data reception apparatus, the transmission paths capable of safely transmitting the transfer object data; and the encryption necessity judging unit judges that the encrypting operation for the transfer object data is necessary except when the table indicates either one or both of the transfer path addresses and domain names thereof of all of the one or more transfer paths.

[Image Forming Apparatus]

The invention provides an image forming apparatus including: a data transmission apparatus for transmitting transfer object data via one or more transfer paths; and a image forming unit for forming image data. The transfer object data includes the image data. The data transmission apparatus includes: an encryption necessity judging unit for judging whether or not encrypting operation for the transfer object data is necessary on the basis of attributes of the one or more transfer paths; an encrypting unit for encrypting the transfer object data when the encryption necessity judging unit judges that the encrypting operation for the transfer object data is necessary; and a data transmitting unit for transmitting either the transfer object data or the encrypted transfer object data via the one or more transfer paths.

[Data Reception Apparatus]

The invention provides a data reception apparatus for receiving transfer object data via one or more transfer paths, including: a data receiving unit for receiving either the transfer object data or the encrypted transfer object data from the data transmission apparatus; a decryption necessity judging unit for judging whether or not decoding operation for the received transfer object data is necessary; and a decoding unit for decoding the received transfer object data when the decryption necessity judging unit judges that the decoding operation for the received transfer object data is necessary.

Preferably, the decryption necessity judging unit judges whether or not the received transfer object data is encrypted based upon either one or both of additional information added to the received transfer object data and an attribute value of the transfer object data; and the decryption necessity judging unit judges that the decoding operation for the received transfer object data is necessary when the transfer object data is judged to be encrypted.

[Image Forming Apparatus]

The invention provides an image forming apparatus including: a data reception apparatus for receiving transfer object data via one or more transfer paths; and a image forming unit for forming image data. The data reception apparatus includes: a data receiving unit for receiving either the transfer object data or the encrypted transfer object data from the data transmission apparatus; a decryption necessity judging unit for judging whether or not decoding operation for the received transfer object data is necessary; and a decoding unit for decoding the received transfer object data when the decryption necessity judging unit judges that the decoding operation for the received transfer object data is necessary.

[Data Transfer Methods]

The invention provides a data transfer method for transferring transfer object data via one or more paths, including: judging whether or not encrypting operation for the transfer object data is necessary on the basis of attributes of the one or more transfer paths; encrypting the transfer object data when the encrypting operation for the transfer object data is judged to be necessary; transmitting either the transfer object data or the encrypted transfer object data via the one or more transfer paths; receiving the transmitted transfer object data; judging whether or not decoding operation for the received transfer object data is necessary; and decoding the received transfer object data when the decoding operation for the received transfer object data is judged to be necessary.

The invention provides a data transmission method for transmitting transfer object data via one or more transfer paths, including: judging whether or not encrypting operation for the transfer object data is necessary on the basis of attributes of the one or more transfer paths; encrypting the transfer object data when the encrypting operation for the transfer object data is judged to be necessary; and transmitting either the transfer object data or the encrypted transfer object data via the one or more transfer paths.

The invention provides a data reception method for receiving transfer object data via one or more transfer paths, including: receiving the transfer object data; judging whether or not decoding operation for the received transfer object data is necessary; and decoding the received transfer object data when the decoding operation for the received transfer object data is judged to be necessary.

[Recording Medium]

The invention provides a recording medium for storing a program to be executed in a data transfer system, wherein the data transfer system includes a data transmission apparatus for transmitting transfer object data and a data reception apparatus for receiving the transfer object data from the data transmission apparatus via one or more transfer paths; the program causing the data transfer system to execute: judging in the data transmission apparatus whether or not encrypting operation for the transfer object data is necessary on the basis of attributes of the one or more transfer paths; encrypting the transfer object data in the data transmission apparatus when the encrypting operation for the transfer object data is judged to be necessary; transmitting either the transfer object data or the encrypted transfer object data from the data transmission apparatus to the data reception apparatus via the one or more transfer paths; judging in the data reception apparatus whether or not decoding operation for the received transfer object data is necessary; and decoding the received transfer object data in the data reception apparatus when the decoding operation for the received transfer object data is judged to be necessary.

The invention provides a recording medium for storing a program to be executed in a data transmission apparatus for transmitting transfer object data via one or more transfer paths, the program causing the data transmission apparatus to execute: judging whether or not encrypting operation for the transfer object data is necessary on the basis of attributes of the one or more transfer paths; encrypting the transfer object data when the encrypting operation for the transfer object data is judged to be necessary; and transmitting either the transfer object data or the encrypted transfer object data via the one or more transfer paths.

The invention provides a recording medium for storing a program to be executed in a data reception apparatus for receiving transfer object data one or more transfer paths, the program causing the data reception apparatus to execute: receiving the transfer object data; judging whether or not decoding operation for the received transfer object data is necessary; and decoding the received transfer object data when the decoding operation for the received transfer object data is judged to be necessary.

### BRIEF DESCRIPTION OF THE DRAWINGS

The present invention may be more readily described with reference to the accompanying drawings:

FIG. 1 is an illustration for exemplifying a structure of a network system to which a data transfer method of the present invention is applied.

FIG. 2 is a diagram for representing a method for transferring encrypted image data from an image forming apparatus to an image forming apparatus.

FIG. 3 is a diagram for exemplifying both a hardware structure of the image forming apparatus and a hardware structure of the image forming apparatus, shown in FIG. 1.

FIG. 4 is a diagram for representing a structure of an image forming/transmitting program capable of realizing the data transfer method according to the present invention.

FIG. 5 is a diagram for representing a structure of a receiving/image forming program capable of realizing the data transfer method according to the present invention.

FIG. 6 is a diagram for exemplifying a transfer frame used to transfer image data by a transmission unit of the image forming/transmitting program shown in FIG. 4.

FIG. 7 is a flow chart for describing a process operation in which an encryption necessity judging unit (FIG. 4) judges as to whether or not encrypting operation of image data is required by employing a network number.

FIG. 8 is a flow chart for describing a process operation in which the encryption necessity judging unit (FIG. 4) acquires a network number from an IP address of a network interposed between the image forming apparatus and the image forming apparatus (FIG. 1 etc.) in the process operation shown in FIG. 7 for judging as to whether or not the encrypting operation of the image data is required.

FIG. 9 is a flow chart for explaining a process operation in which the encryption necessity judging unit (FIG. 4) judges as to whether or not the encrypting operation of the image data is required by employing a private address.

FIG. 10 is a flow chart for describing a process operation in which the encryption necessity judging unit (FIG. 4) acquires a network number from an IP address of a network interposed between the image forming apparatus and the image forming apparatus (FIG. 1 etc.) in the process operation indicated in FIG. 9.

FIG. 11 is a flow chart for explaining a process operation in which the encryption necessity judging unit (FIG. 4) judges as to whether or not the encrypting operation of the image data is required by employing an organization domain name.

FIG. 12 is a flow chart for describing a process operation in which the encryption necessity judging unit (FIG. 4) acquires an organization domain name from an IP address of a network interposed between the image forming apparatus and the image forming apparatus (FIG. 1 etc.) in the process operation shown in FIG. 11.

FIG. 13 exemplifies a content of a table for indicating network numbers of networks through which image data can be transferred in a safe manner among networks which may be interposed from an image forming apparatus up to such image forming apparatus indicated as indexes.

FIG. 14 is a diagram for representing a process operation in which the encryption necessity judging unit (FIG. 4) judges as to whether or not encrypting operation is required by using the table exemplified in FIG. 13.

FIG. 15 exemplifies a content of a table for indicating organization domain names of networks through which image data can be transferred in a safe manner among networks which may be interposed from an image forming apparatus up to such image forming apparatus indicated as indexes.

FIG. 16 is a diagram for representing a process operation in which the encryption necessity judging unit (FIG. 4) judges as to whether or not encrypting operation is required by using the table exemplified in FIG. 15.

### DETAILED DESCRIPTION OF THE PREFERRED EMBODIMENTS

[Background]

For an easy understanding of the present invention, a background why the present invention could be made will now be firstly explained.

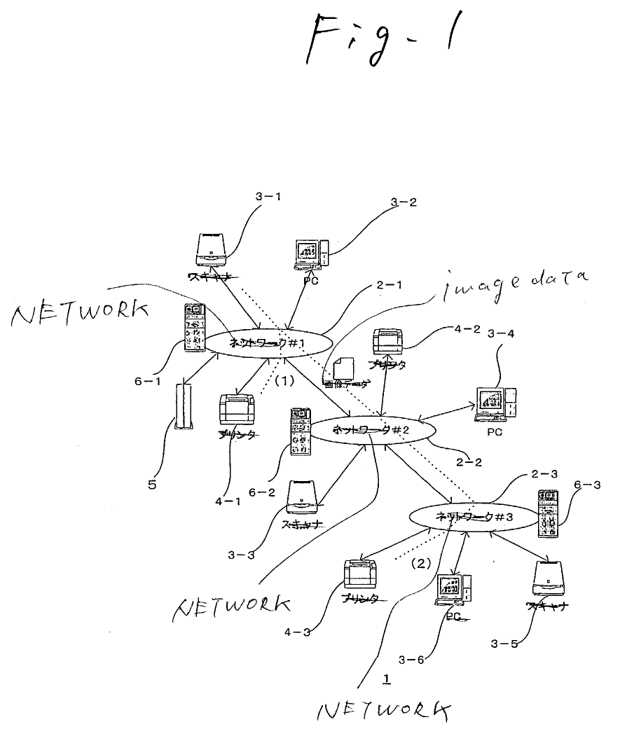

FIG. 1 exemplifies an arrangement of a network system 1 to which a data transfer method according to the present invention is applied.

As indicated in FIG. 1, the network system 1 contains first to third networks 2-1 to 2-3; image forming apparatus 3-1 to 3-6; image forming apparatus 4-1 to 4-3; a DNS 5; and router appliances 6-1 to 6-3.

It should also be noted that both systems and apparatus related to transferring operations of image data such as the networks 2 and the router appliances 6 will also be referred to as a general term of “a transfer path.”

In the case that systems and apparatus are generically called without specifying any one of plural structural components, these systems and apparatus will be abbreviated as, for example, the networks 2, and the router appliances 6.

The networks 2-1 to 2-3 (transfer paths) are managed by the same organization, or the different organizations, respectively, and are mutually connected to each other in order to transfer data.

The image forming apparatus 3-1 to 3-6 correspond to such client apparatus as scanners and computers (PCs) which produce print jobs.

The respective image forming apparatus 3-1 to 3-6 produce image data, and transfer these produced image data to any one of the image forming apparatus 4-1 to 4-3 via the networks 2-1 to 2-3.

The image forming apparatus 4-1 to 4-3 correspond to print server apparatus such as printers and copy hybrid machines. The image forming apparatus 4-1 to 4-3 form images (print out) based upon image data transferred from the respective image forming apparatus 3-1 to 3-6.

In other words, in the network system 1, both network-distributed printing operation and network-distributed copying operation are carried out.

In such a case that the network-distributed printing operation is carried out, image data designed for image forming operation may be transferred over a plurality of networks 2-1 to 2-3, which is different from such a case that either a single printer or a copy hybrid machine is employed.

For instance, as indicated by applying a numeral (1) in FIG. 1, in such a case that image data produced by the image forming apparatus 3-1 is transferred via the network 2-1 belonging to the same organization to the image forming apparatus 4-1 so as to form an image, since a security aspect of a transfer path can be sufficiently guaranteed, there are many possibilities that no problem occurs even when the image data is transferred without being encrypted.

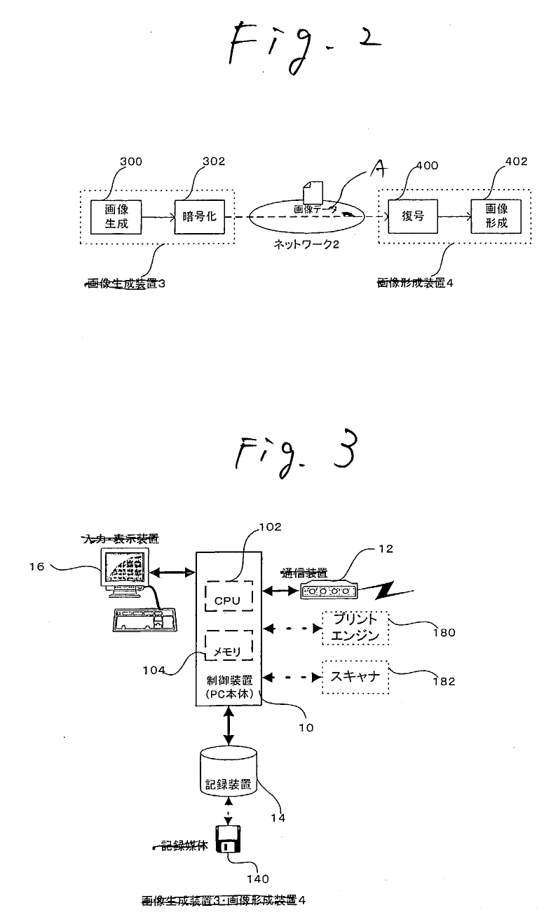

FIG. 2 is a diagram for indicating a method for transferring encrypted image data from the image forming apparatus 3 with respect to the image forming apparatus 4.

On the other hand, as indicated by applying a numeral (2) in FIG. 1, in such a case that image data produced by the image forming apparatus 3-1 is transferred via the networks 2-1 to 2-3 belonging to the different organizations to the image forming apparatus 4-3 so as to form an image, since a security aspect of a transfer path cannot be sufficiently guaranteed, when such as image data having high secrecy is transferred, this image data is required to be encrypted.

In the case that image data is encrypted, an encrypting unit 302 is required to be additionally provided on the side of the image forming apparatus 3, and a decoding unit 400 is required to be additionally provided on the side of the image forming apparatus 4.

In other words, in such a case, image data produced by the image forming unit 300 is encrypted by the encrypting unit 302 on the side of the image forming apparatus 3, and then, the encrypted image data is transferred via the network 2 to the image forming apparatus 4. On the side of the image forming apparatus 4, the received image data is decoded by the decoding unit 400, and then, the decoded image data is processed by the image forming unit 402 to form an image.

It should be understood that in order to achieve a similar object, while an encrypted secret telephone communication path is established between the image forming apparatus 3 and the image forming apparatus 4, such a method for transferring image data may be conceived by employing this encrypted secret telephone communication path.

However, generally speaking, a method for encrypting image data is merely different from a method of using a secret telephone communication path only as to such a fact that only the image data is encrypted, whereas a control message in addition to the image data are furthermore encrypted.

Accordingly, for the sake of clear and simple explanations, these methods will not be discriminated from each other in the below-mentioned descriptions.

On the other hand, in general, the shorter a time duration (namely, job end time) becomes, the better the result is obtained irrespective of such a condition that the image forming apparatus 4 is employed which is connected via a network to the image forming apparatus 3, otherwise the image forming apparatus 4 is employed which is directly connected to the image forming apparatus 3. This job end time is defined by that after a reading operation of an original has been commenced on the side of the image forming apparatus 3 (scanner), a printing operation is accomplished on the side of the image forming apparatus 4.

In this case, with respect to a data size of image data to be printed, in the case that this image data size is made of 24-bit full color (namely, 24 bits/pixel), even when the image data is compressed by approximately 1/30 per one A4-sized page (7040×4992 pixels), the resulting data size becomes approximately 3.5 megabytes (Mbytes), namely large.

To the contrary, both time required to read an original having one A4-paper size by a highspeed scanner apparatus (image forming apparatus 3), and time required to print image data having one A4-paper size by a highspeed printer (image forming apparatus 4) are nearly equal to 1 to 2 seconds.

As a consequence, throughputs defined from approximately 10 Mbits/second up to several tens Mbits/second may be desirably obtained as a data rate at which image data is transferred so as to be printed irrespective of such a condition that the image forming apparatus 4 is employed which is connected via a network to the image forming apparatus 3, otherwise the image forming apparatus 4 is employed which is directly connected to the image forming apparatus 3.

For example, in such a case that image data is transferred between a scanner and an image forming unit which are mutually connected within a copy machine, the above-described throughputs may be achieved in a very simple manner.

On the other hand, even in such a case that image data is transferred via a network, when a data transfer path is routed only via the same LANs (Local Area Networks), or only via a highspeed communication line such as the FTTH (Fiber to the Home), since throughputs of these networks are approximately several tens to 100 Mbits/second, namely are sufficiently high, these highspeed throughputs never give any problem to the image data transfer operations, the transfer speed of which is defined from approximately 10 Mbits/second up to several tens Mbits/second.

However, as indicated in FIG. 2, when the network-distributed printing operation is carried, in such a case that the image data is required to be encrypted/decoded, if the calculating process operations required to execute the encrypting/decoding process operations are carried out within both the image forming apparatus 3 and the image forming apparatus 5, and the processing capability of the CPUs employed in the image forming apparatus 3 and the image forming apparatus 4 is low, then there are some cases that sufficiently high throughputs cannot be obtained.

To solve this problem, for example, when a user who requests a printing operation transfers image data, such a method may be employed. That is, this user clearly issues such an instruction as to whether or not this image data is encrypted to the image forming apparatus 3, and instructs not to perform unnecessary encrypting operation of the image data so as to improve the throughput.

However, if this method is employed, then a user must have expertise, namely knowledge as to whether or not encrypting operation is required for image data is necessarily required for this user.

In other words, in order to employ this method, such an initial condition is required. That is, the user who performs copying operation must have such an expertise as to whether or not the network 2 whose security cannot be protected is interposed between the image forming apparatus 3 and the image forming apparatus 4, which execute the network-distributed printing operation.

As a consequence, the employment of this method cannot be actually realized.

A data transfer method, according to the present invention, has been made based upon such a background. This inventive data transfer method is capable of solving the problems of the conventional techniques indicated with reference to Publication 1 and Publication 2, and further, is capable of executing encrypting/decoding process operations by employing general-purpose hardware in conformity with the standardized encrypting system. Moreover, this data transfer method is capable of improving a throughput of an image data transfer operation during network-distributed printing operation, while a user is not required to have expertise with respect to security aspects on a data transfer path.

Concretely speaking, the data transfer method according to the present invention may judge as to whether or not a place whose security cannot be protected is located in an image data transfer path which is interposed between the image forming apparatus 3 and the image forming apparatus 4 and also may improve a throughput of an image data transferring operation in such a manner that the image data is transferred with being encrypted, or without being encrypted based upon the judgement result.

The data transfer method according to the present invention has been made by paying an attention to the below-mentioned technical points.

In general, within a range of a network called as a LAN (Local Area Network), namely within a range of such a network which is managed by an organization where merits/demerits are made coincident with each other, for instance, within one firm, since security of image data may be maintained which is transferred within this network range, it is conceivable that the image data are transferred in a safety manner.

As a consequence, the data transfer method can judge as to whether or not image data is required to be encrypted by checking as to whether or not all of networks contained in a transfer path of the image data are managed by an organization in which both the image forming apparatus 3 and the image forming apparatus 4 are contained.

Generally speaking, in the case that image data is transferred by using an IP (Internet Protocol) packet, respective IP addressees of router appliances (transfer paths) contained in the networks 2 which are located in paths defined from a transfer source of the IP packet to a transfer destination of the IP packet may be obtained by way of a method called as a “TRACE ROUTE.”

An IP address indicative of a destination thereof is applied to an IP packet, and an IP address is constituted by a network address portion and a host address portion.

As to an IP address, two sorts of IP addresses are provided, namely, a global address and a local address are provided. In the case of such a global address, values of a network address portion are uniquely allocated to each of organizations which manage networks.

As a consequence, the respective managing organizations of the networks contained in the transfer path of the image data can be specified based upon network addresses thereof.

Also, in the case that local addresses are employed as to all of networks contained in the transfer path of the image data, it is conceivable that these networks are located within the range of this LAN.

Also, in the Internet protocol suite, the DNS (Domain Name System) is defined which exclusively names IP addresses.

In a DNS 5 (domain name server shown in FIG. 1) operated in conformity with the Internet protocol suite, the respective domains (IP addresses) are defined in correspondence with hierarchical names such as country names, organization attributes, organization names, and host names.

As a consequence, since a service provided by the DNS 5 is utilized, a domain name (host name) of an apparatus defined in correspondence with a certain IP address may be retrieved based upon this IP address.

Accordingly, based upon a host name of a router appliance which is contained in the network 2 constituted as the transfer path of the image data, an organization belonging to this host name may be grasped.

Also, generally speaking, as viewed from the side of the image forming apparatus 3 for executing the network-distributed printing operation, such an expectation may be made. That is, a certain image forming apparatus may be repeatedly designated as a destination of image data among the image forming apparatus 4.

Also, generally speaking, another expectation may be made. That is, a transfer path of image data is fixedly determined with respect to combinations between the image forming apparatus 3 and the image forming apparatus 4, which execute the network-distributed printing operation.

As a consequence, security aspects of networks contained in paths through which image data are frequently transferred may be previously investigated every combination between the specific image data producing apparatus 3 and the specific image forming apparatus 4, which may become effective so as to judge the security aspects.

[Embodiments Mode]

Embodiment modes of the present invention will now be explained as follows:

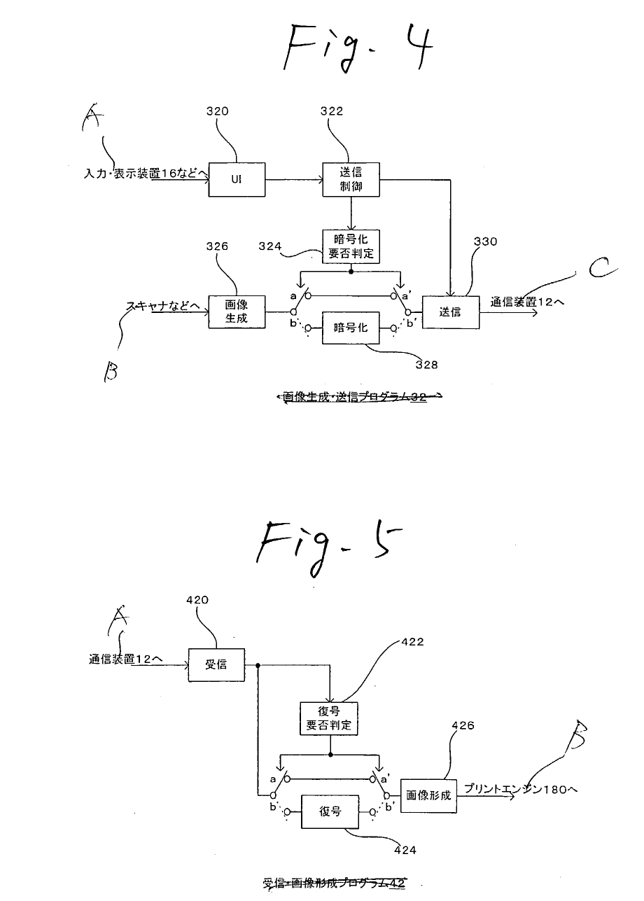

FIG. 3 is a diagram for exemplifying a hardware structure of both the image forming apparatus 3 and the image forming apparatus 4 shown in FIG. 1.

As indicated in FIG. 3, both the image forming apparatus 3 and the image forming apparatus 4 contain a control apparatus 10 including a CPU 102 and a memory 104; a communication apparatus 12; a recording apparatus 14; and an input/display apparatus 16. In the case that the image forming apparatus 3 is a PC (Personal Computer), this control apparatus 10 corresponds to a main body of this PC.

Also, in the case that the image forming apparatus 3 is a scanner apparatus, the image forming apparatus 3 contains a scanner 182, as indicated by a dotted line in FIG. 3.

Also, as shown in FIG. 2, the image forming apparatus 4 includes a print engine 180 which prints image data received via both the network 2 (FIG. 1) and the communication apparatus 12.

In other words, each of the image forming apparatus 3 and the image forming apparatus 4 contains a structural portion as both a network client and a print server, which can transfer image data via a network.

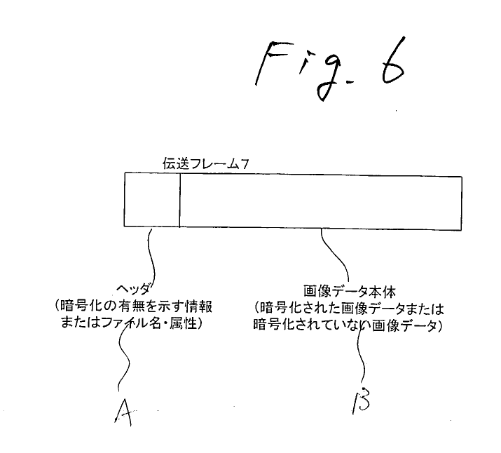

FIG. 4 is a diagram for indicating a structure of an image forming/transmitting program 32 used to realize the data transfer method according to the present invention.

FIG. 5 is a diagram for indicating a structure of a receiving/image-forming program 42 used to realize the data transfer method according to the present invention.

The image-forming/transmitting program 32 shown in FIG. 4 is constructed of a user interface (UI) unit 320, a transmission control unit 322, an encryption necessity judging unit 324, an image forming unit 326, an encrypting unit 328, and a transmission unit 330.

The receiving/image-forming program 42 indicated in FIG. 5 is constituted by a reception unit 420, a decryption necessity judging unit 422, a decoding unit 424, and an image forming unit 426.

It should be noted that for the sake of simple illustrations, lines indicative of a data flow are properly omitted in FIG. 4 and FIG. 5.

Each of the image forming/transmitting program 32 and the receiving/image-forming program 42 is supplied via either the recording medium 140 or the network 2 to both the image forming apparatus 3 and the image forming apparatus 4, and is loaded to the memory 104, and then is executed.

Both the image-forming/transmitting program 32 and the receiving/image-forming program 42 may realize the data transfer method according to the present invention in conjunction with each other.

In the image-forming/transmitting program 32 (see FIG. 4), the UI unit 320 enters operations made by a user from the input/display apparatus 16, and outputs information indicative of the entered operation with respect to the transmission control unit 322, and the like.

The transmission control unit 322 enters from the UI unit 320 and the like, such an information required to produce/transmit image data, for example, either a network address or a domain name of an image forming apparatus 4 functioning as a transmission destination of image data. Then, the transmission control unit 322 controls the transmission unit 330 so as to transmit such an image data produced by the image forming unit 326 via the network 2 to the image forming apparatus 4.

Also, the transmission control unit 322 outputs to the encryption necessity judging unit 324, such an information required to specify the network 2 interposed between the image forming apparatus 3 and the image forming apparatus 4, for instance, the network address of the image forming apparatus 4 among the information entered from the UI unit 320.

The encryption necessity judging unit 324 is set via the UI unit 320, the communication apparatus 12, or the recording apparatus (FIG. 3), and stores thereinto both network information required to acquire such a fact that what sort of network is interposed between the image forming apparatus 3 and the image forming apparatus 4, and another information required to judge as to whether or not the interposing network 2 is safe.

Also, the encryption necessity judging unit 324 judges as to whether or not each of the networks 2 interposed between the image forming apparatus 3 and the image forming apparatus 4 is made safe in order to transfer image data by using the stored network information and the IP address of the image forming apparatus 4 functioning as the data transfer destination.

The encryption necessity judging unit 324 judges that the encrypting operation by the encrypting unit 328 is not required only in such a case that all of the interposing networks 2 are made safe, and also judges that the encrypting operation by the encrypting unit 328 is required in any cases other than the first-mentioned case, and then, controls the encrypting unit 328 in accordance with this judgment result.

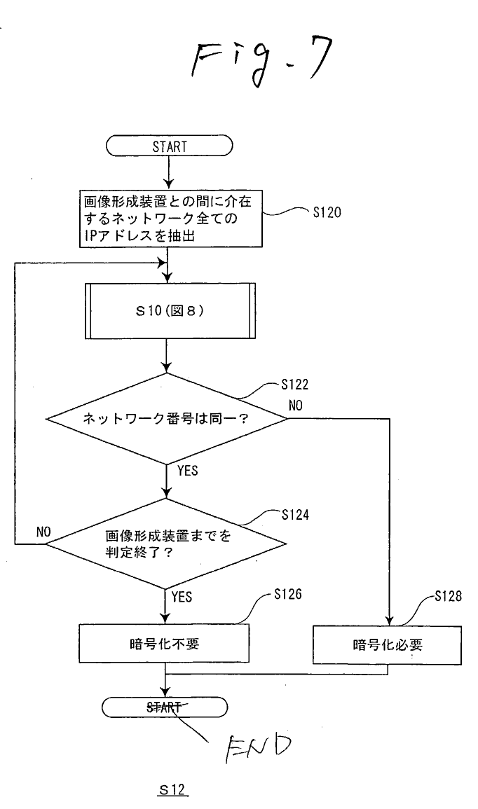

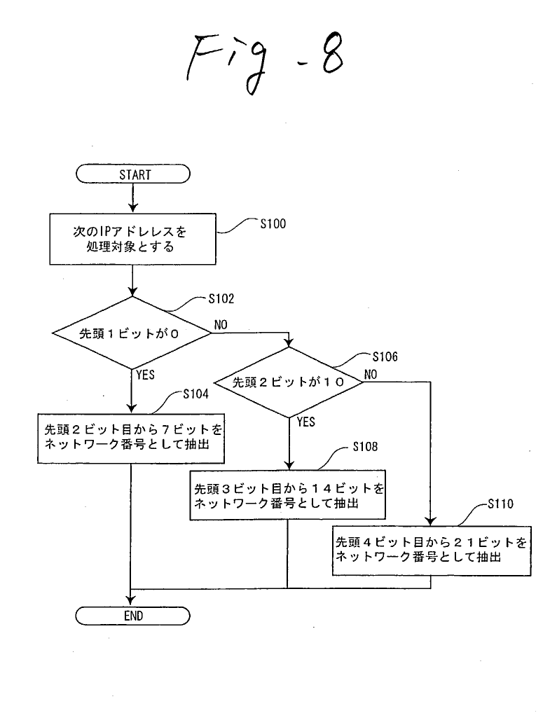

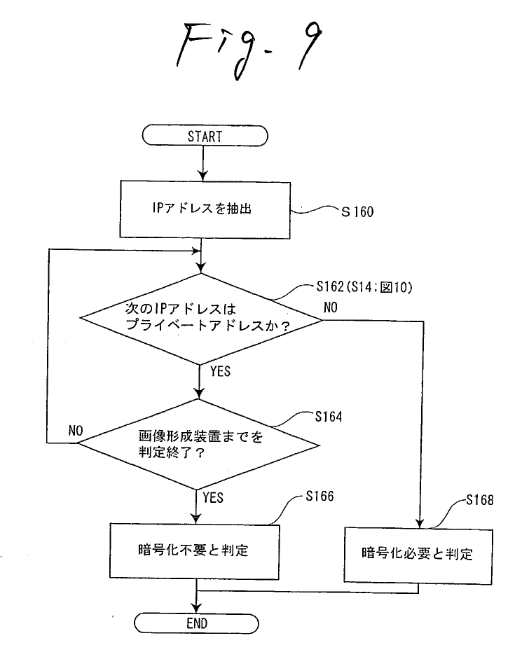

It should also be noted that the methods for judging as to whether or not the encrypting operation by the encryption necessity judging unit 324 and the decoding operation by the decryption necessity judging unit 422 will be lately described in detail with reference to FIG. 7 to FIG. 16.

The image forming unit 326 controls the scanner 182 and the like so as to produce image data in response to operation by a user, and outputs the produced image data with respect to the encrypting unit 328.

The encrypting unit 328 encrypts, or does not encrypt the image data entered from the image forming unit 326 based upon a judgment result of the encryption necessity judging unit 324, and then outputs the resulting image data to the transmission unit 330.

FIG. 6 is a diagram for exemplifying a transfer frame 7 which is employed by the transmission unit 330 of the image forming/transmitting program 32 shown in FIG. 4 in order to transfer image data.

The transmission unit 330 transmits either the encrypted image data or the not-encrypted image data, which are entered from the encrypting unit 328, via both the communication apparatus 12 (FIG. 3) and the network 2 with respect to the image forming apparatus 3 under control of the transmission control unit 322.

It should be noted that the transmission unit 330 stores the image data into the transfer frame 7 shown in FIG. 6 and then transmits the resultant image data. This transmission unit 330 contains the IP address of the image forming apparatus 3 functioning as the transmission source and the IP address of the image forming apparatus 4 functioning as the transmission destination; and either such an information or such a data indicative of the file name/attribute of the image data in the header portion of this transfer frame 7. This information indicates as to whether or not the image data contained in this transfer frame 7 has been encrypted.

In the receiving/image forming program 42, the reception unit 420 receives the transfer frame 7 containing the image data (FIG. 6) which has been transferred from the image forming apparatus 3 via the network 2, and then outputs either the encrypted image data or the not-encrypted image data to the decoding unit 424.

Also, the reception unit 420 outputs such an information for indicating as to whether or not the image data contained in the header of the received transfer frame 7 has been encrypted to the decoding-require/not-require unit 422. Otherwise, the reception unit 420 outputs to the decoding-require/not-require unit 422, such an information as the file name of the image data which can be employed in order to judge as to whether or not the image data has been encrypted.

Similar to the encryption necessity judging unit 324, the decryption necessity judging unit 422 holds both the network information required to acquire the network 2 interposed between the image forming apparatus 3 and the image forming apparatus 4, and the information required to judge as to whether or not the interposing network 2 is safe in order to transfer the image data.

The decryption necessity judging unit 422 judges that the received image data is not encrypted based upon this information and the IP address of the image forming apparatus 3 functioning as the transmission source, which is contained in the header of the transfer frame 7, only in such a case that all of the networks 2 interposed between the image forming apparatus 3 and the image forming apparatus 4 are made safe, and also judges that the received image data has been encrypted in any cases other than the first-mentioned case (namely, decryption necessity judging method 1).

Otherwise, the decryption necessity judging unit 422 judges as to whether or not the image data contained in the same transfer frame has been encrypted based upon such an information indicating as to whether or not the image data has been encrypted, which is contained in the header of the received transfer frame 7.

Otherwise, the decryption necessity judging unit 422 judges as to whether or not the image data contained in the same transfer frame has been encrypted based upon such a fact as to whether or not the attribute value of the file name of the image data contained in the header of the received transfer frame 7 indicates the encrypted file (namely, decryption necessity judging method 2).

The decryption necessity judging unit 422 judges as to whether or not the image data contained in the transfer frame 7 has been encrypted in accordance with any one of the above-described decryption necessity judging methods 1 and 2. In the case that the image data has been encrypted, the decryption necessity judging unit 422 judges that the decoding operation is required for the image data and thus control the decoding unit 424.

Also, when the image data is not encrypted, the decryption necessity judging unit 422 judges that the decoding operation is not required for the image data, and thus controls the decoding unit 424.

The decoding unit 424 decodes the image data entered from the reception unit 420, or does not decode the image data inputted from the reception unit 420, and then, outputs the resultant image data to the image forming unit 426 under control of the decryption necessity judging unit 422.

The image forming unit 426 controls the print engine 180 (FIG. 3) so as to print the image data entered from the decoding unit 424.

[Judgements Executed by Encryption Necessity Judging Unit 324 and Decryption Necessity Judging Unit 422]

Both the encryption necessity judging method by the encryption necessity judging unit 324 (FIG. 4) and the decryption necessity judging method by the decryption necessity judging unit 422 (FIG. 5) will be further explained in detail, while judging cases are classified every information employed in the require/not-require judgment.

[Method of Employing Network Number]

An IP address of an image forming apparatus 4 as an image data transmitting destination owns a data length of 32 bits (in case of IP version-4 protocol), and is classified into three sorts of IP addresses (namely, class A, class B, and class C) by combining data lengths of network address portions with data lengths of host address portions.

It should be understood that although other classes are involved in the classification of the IP address, these classes are not related to the data transfer method according to the present invention, so that explanations thereof are omitted.

The IP address of the class A is arranged by the network address portion having the 7-bit length and the host address portion having the 24-bit length.

The head bit of the IP address of this class A is equal to “0 (zero)”, and it is possible to identify as to whether or not this IP address is the class A by checking as to whether or not the head bit of the IP address is equal to “0.”

The IP address of the class B is arranged by the network address portion having the 14-bit length and the host address portion having the 16-bit length. It is possible to identify as to whether or not this IP address is the class B by checking as to whether or not the head bit of the IP address is equal to “10.”

The IP address of the class C is arranged by the network address portion having the 21-bit length and the host address portion having the 8-bit length. It is possible to identify as to whether or not this IP address is the class C by checking as to whether or not the head bit of the IP address is equal to “110.”

Based upon the above-described rule, the network addresses (network numbers) of the networks 2 interposed between the image forming apparatus 3 functioning as the transmission source of the image data and the image forming apparatus 4 functioning as the transmission destination of the image data can be readily extracted from the respective IP addresses of these networks 2.

Furthermore, it is possible to judge as to whether or not the respective networks are made safe in order to transfer the image data by employing the network numbers of these networks 2 interposed between the extracted image forming apparatus 3 and the extracted image forming apparatus 4.

As a simple concrete example, in such a case that network numbers of all of the networks 2 interposed between the image forming apparatus 3 and the image forming apparatus 4 are identical to each other, since all of these networks 2 are managed by such an organization to which both the image forming apparatus 3 and the image forming apparatus 4 belong, it is possible to judge that all of these networks 2 are made safe in order to transfer image data, and also possible to judge such a fact that there are some possibilities that all of these networks are not made safe in any cases other than the first-mentioned case.

As a consequence, in this case, the encryption necessity judging unit 324 of the image forming/transmitting program 32 (FIG. 4) can judge that the encrypting operation is not required only in such a case that network numbers of all of the networks 2 interposed between the image forming apparatus 3 and the image forming apparatus 4 are identical to each other. Also, the decryption necessity judging unit 422 of the receiving/image forming program 42 can judge that the decoding operation is not required only in this case.

It should also be noted that for the sake of more concrete/clear explanations, flow charts indicated in FIG. 7 to FIG. 16 describe only the judgement operation as to whether or not the encryption is required by the encryption necessity judging unit 324 in the below-mentioned descriptions. However, the decryption necessity judging unit 422 may judge as to whether or not the decoding operation is required in a similar process operation.

FIG. 7 is a flow chart for describing a process operation (S12) of the encryption necessity judging unit 324 (FIG. 4) which judges as to whether or not encrypting operation image data is required by employing a network number.

FIG. 8 is a flow chart for describing a process operation (S10) of the encryption necessity judging unit 324 (FIG. 4) which acquires a network number from an IP address of a network 2 interposed between the image forming apparatus 3 and the image forming apparatus 4 (see FIG. 1 and the like) in a process operation for judging as to whether or not encrypting operation of image data shown in FIG. 8 is needed.

As indicated in FIG. 7, in a step 120 (S120), the encryption necessity judging unit 324 extracts IP addresses of all of networks 2 which are interposed from an image forming apparatus 3 functioning as a transmission source of image data up to an image forming apparatus 4 functioning as a transmission destination of the image data.

In a step 10 (S10), as will be described later with reference to FIG. 8, the encryption necessity judging unit 324 extracts a network number of such a network 2 (next network) which has not yet be judged as to whether or not the encrypting operation is required among more than one network 2 interposed from the image forming apparatus 3 up to the image forming apparatus 4.

In a step 122 (step 122), the encryption necessity judging unit 324 judges as to whether or not a network number of a network 2 which has been finally extracted in the process operation of the step S10 is made coincident with a network number (first network number) of a network 2 to which the image forming apparatus 3 of the image transmission source belongs.

In the case that these network numbers are identical to each other, the process operation by the encryption necessity judging unit 324 is advanced to a further step S124, whereas the process operation by the encryption necessity judging unit 324 is advanced to another process operation of a step S128 in any cases other than the first-mentioned case.

In a step 124 (S124), the encryption necessity judging unit 324 judges as to whether or not the encryption necessity judging operations have been accomplished with respect to all of the networks which are interposed between the image forming apparatus 3 and the image forming apparatus 4, and also contain the network 2 (first network) to which the image forming apparatus 3 functioning as the transmission source of the image data belongs, and further contain the network 2 to which the image forming apparatus 4 functioning as the transmission destination of the image data belongs.

In the case that the encryption necessity judging operations are accomplished, this process operation is advanced to a process operation of a step S126, and is returned to the previous step S10 in any cases other than this case.

In a step 126 (S126), the encryption necessity judging unit 324 judges that the encrypting operation for the image data is not required.

In a step 128 (S128), the encryption necessity judging unit 324 judges that the encrypting operation for the image data is required.

As indicated in FIG. 8, in a step 100 (S100), the encryption necessity judging unit 324 sets an IP address of a next network 2 as an extracting process subject of a network number.

In a step 102 (S102), the encryption necessity judging unit 324 judges as to whether or not a head bit of the IP address which should be extracted is equal to “0” in the process operation of S100.

In the case that this head bit is equal to “0”, the process operation of the encryption necessity judging unit 324 is advanced to a process operation of S104, and is advanced to a process operation of S106 in any cases other than the above case.

In the step 104 (S104), the encryption necessity judging unit 324 extracts such IP address bits defined from a 2nd bit up to a 7th bit counted from the head bit as a network address.

In a step 106 (S106), the encryption necessity judging unit 324 judges as to whether or not head 2 bits of the IP address which should be extracted are equal to “10” in the process operation of S100.

In the case that the head 2 bits are equal to “10”, the process operation of the encryption necessity judging unit 324 is advanced to a process operation of S108, and is advanced to a process operation of S110 in any cases other than the above case.

In the step 108 (S108), the encryption necessity judging unit 324 extracts such IP address bits defined from a 3rd bit up to a 14th bit counted from the head bit as a network address.

In the step 110 (S110), the encryption necessity judging unit 324 extracts such IP address bits defined from a 4th bit up to a 21st bit counted from the head bit as a network address.

[Method by Employing Private Address]

While there are two cases that an IP address of an image forming apparatus 4 functions as a destination of image data corresponds to a private address, or a global address, the private address with respect to the image forming apparatus 4 may be freely allocated in the below-mentioned range:

In the case that the IP address is the class A, the private address may be allocated to such a range of 10. 0. 0. 0-10. 255. 255. 255.

In the case that the IP address is the class B, the private address may be allocated to such a range of 172. 16. 0. 0-172. 16. 255. 255.

In the case that the IP address is the class C, the private address may be allocated to such a range of 192. 168. 0. 0-192. 168. 255. 255.

It is possible to readily judge as to whether or not the respective IP addresses of the networks 2 interposed between the image forming apparatus 3 functioning as the transmission source of the image data and the image forming apparatus 4 functioning as the transmission destination of the image data correspond to the private addresses based upon the above-explained rule.

As a simple concrete example, in such a case that IP addresses of all of the networks 2 interposed between the image forming apparatus 3 of the transmission source and the image forming apparatus 4 of the transmission destinations correspond to the private addresses, since all of these networks 2 are managed by such an organization to which both the image forming apparatus 3 and the image forming apparatus 4 belong, it is possible to judge that all of these networks 2 are made safe in order to transfer image data, and also possible to judge such a fact that there are some possibilities that all of these networks are not made safe in any cases other than the first-mentioned case.

As a consequence, in this example, the encryption necessity judging unit 324 of the image forming/transmitting program 32 (FIG. 4) can judge that the encrypting operation is not required only in such a case that the IP addresses of all of the networks interposed between the image forming apparatus 4 and the image forming apparatus 3 correspond to the private addresses. Also, the decryption necessity judging unit 422 of the receiving/image forming program 42 can judge that the decoding operation is not required only in this case.

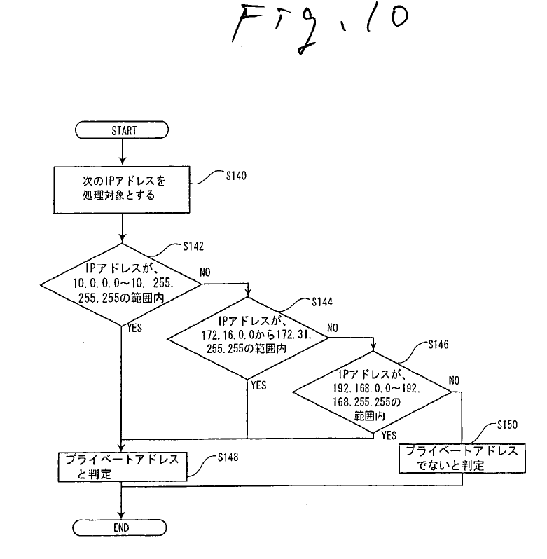

FIG. 9 is a flow chart for describing a process operation (S16) of the encryption necessity judging unit 324 (FIG. 4) which judges as to whether or not encrypting operation of image data is required by employing a private address.

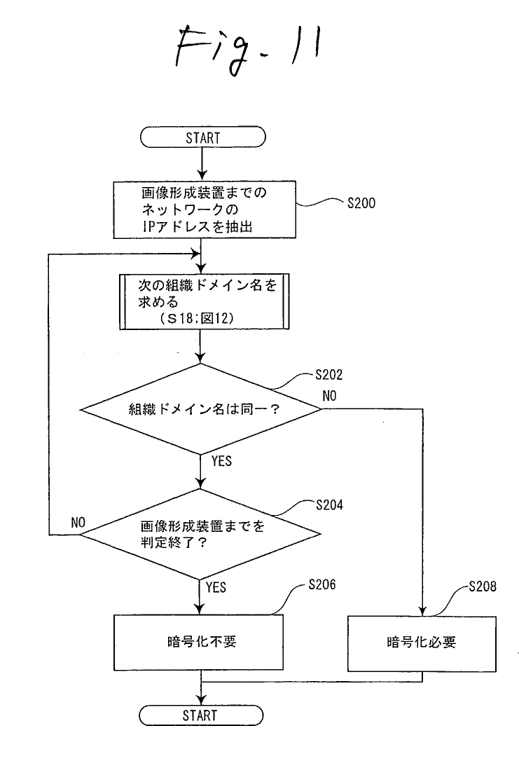

FIG. 10 is a flow chart for describing a process operation (S14) of the encryption necessity judging unit 324 (FIG. 4) which acquires a network number from an IP address of a network 2 interposed between the image forming apparatus 3 and the image forming apparatus 4 (see FIG. 1 and the like) in a process operation defined in a step S162 shown in FIG. 9.

As indicated in FIG. 9, in a step 160 (S160), the encryption necessity judging unit 324 extracts IP addresses of all of networks 2 which are interposed between the image forming apparatus 3 and the image forming apparatus 4.

In a step 162 (S162), the encryption necessity judging unit 324 executes a process operation defined in a step S14 shown in FIG. 10, and judges as to whether or not an IP address of such a network 2 (next network) which has not yet been judged as to the encrypting-require/not-require aspect corresponds to the private address among networks which are defined from the network 2 (first network) to which the image forming apparatus 3 belongs up to the network 2 to which the image forming apparatus 4 belongs.

In the case that the next IP address corresponds to the private address, the process operation of the encryption necessity judging unit 324 is advanced to a process operation of a step S164, and is advanced to another process operation of a step S168 in any cases other than the above-described case.

In a step 164 (S164), the encryption necessity judging unit 324 judges as to whether or not the encryption necessity judging operations have been accomplished with respect to all of the networks which are interposed between the image forming apparatus 3 and the image forming apparatus 4, and also contain the network 2 (first network) to which the image forming apparatus 3 functioning as the transmission source of the image data belongs, and further contain the network 2 to which the image forming apparatus 4 functioning as the transmission destination of the image data belongs.

In the case that the encryption necessity judging operations are accomplished with respect to all of the networks 2, this process operation is advanced to a process operation of a step S166, and is returned to the previous step S162 in any cases other than the first-mentioned case.

In the step 166 (S166), the encryption necessity judging unit 324 judges as to whether or not the encrypting operation for the image data is required.

In the step 168 (S168), the encryption necessity judging unit 324 judges as to whether or not the encrypting operaiton for the image data is required.

As indicated in FIG. 10, the encryption necessity judging unit 324 processes an IP address of a next network 2 in a step 140 (S140).

In a step 142 (S142), the encryption necessity judging unit 324 judges as to whether or not the IP address to be processed is present within the range of 10. 0. 0. 0-10. 255. 255. 255.

In such a case that the IP address is present within this range, the process operation of the encryption necessity judging unit 324 is advanced to a process operation of a step S148, and is advanced to another process operation of a step S144 in any cases other than the first-mentioned case.

In a step 144 (S144), the encryption necessity judging unit 324 judges as to whether or not the IP address to be processed is present within the range of 172. 16. 0. 0-172. 31. 255. 255.

In such a case that the IP address is present within this range, the process operation of the encryption necessity judging unit 324 is advanced to a process operation of a step S148, and is advanced to another process operation of a step S146 in any cases other than the first-mentioned case.

In a step 146 (S146), the encryption necessity judging unit 324 judges as to whether or not the IP address to be processed is present within the range of 192. 168. 0. 0-192. 168. 255. 255.

In such a case that the IP address is present within this range, the process operation of the encryption necessity judging unit 324 is advanced to the process operation of the step S148, and is advanced to another process operation of a step S150 in any cases other than the first-mentioned case.

In the step 148 (S148), the encryption necessity judging unit 324 judges that the IP address to be processed corresponds to the private address.

In the step 150 (S150), the encryption necessity judging unit 324 judges that the IP address to be processed does not corresponds to the private address.

[Method by Employing Domain Name]

As previously explained, domain names which can be retrieved by the DNS (Domain Name Server) 5 employ a hierarchical structure in such a way that a retrieving operation can be sequentially carried out with respect to domains at a top level, domains corresponding to subdivided organizations, and host names.

Concretely speaking, as the domains at the top level, there are two sorts of such domains, namely, gTLD (global top-level domain) and ccTLD (country code top-level domain) The former domain “gTLD” contains such a domain name as “com”, “net”, “org”, which indicates an attribute of a lower-grade domain and is commonly available all over the world. The latter domain “ccTLD” contains such a country domain name as “jp (Japan)”, “uk (United Kingdom)”, “ca (Canada).”

Also, there is a hierarchical structure lower than the country domains. For example, in the case of the jp domain, this jp domain is constructed of an attribute type lower-grade domain and a regional type lower-grade domain.

The attribute type domain implies such a domain corresponding to an attribute type of organization, e.g., a company (co domain), a university (ac domain), and a government (go domain). The regional type domain implies such a domain corresponding to a regional government, e.g., Tokyo (tokyo domain), and Kanagawa (kanagawa domain).

In the data transfer method according to the present invention, for instance, the domains up to the secondary domain of the gTLD domain within the hierarchical structure of the domain name are assumed as a domain (namely, organization domain name) indicative of such an organization that image data can be transferred in a safe manner within this range, while the same merits/demerits can be obtained.

Also, similarly, in the data transfer method according to the present invention, for instance, the domains up to the thirdly domain of the ccTLD domain having the attribute type secondary domain are assumed as an organization domain name.

A more concrete explanation will now be made of an organization domain name representative of such a organization in which image data can be transferred in a safe manner.

For example, in the case that a host name is “hostname. divisionname. companyname. com”, a name portion of “companyname. com” corresponds to this organization domain name.

For example, in the case that a host name is “hostname. divisionname. companyname. co. jp”, a name portion of “companyname. co. jp” corresponds to this organization domain name.

As previously described, organization domain names are extracted from domain names of networks 2 interposed between the image forming apparatus 3 and the image forming apparatus 4, and if the organization domain names of all of these networks are identical to each other, then it is possible to judge that the image data can be transferred in the safe manner from the image forming apparatus 3 to the image forming apparatus 4. In any cases other than the above-explained case, such a judgment can be made. That is, there are some possibilities that the image data cannot be transferred in the safe manner from the image forming apparatus 3 to the image forming apparatus 4.

As a consequence, in the case that all of the organization domain names of the networks 2 interposed between the image forming apparatus 3 and the image forming apparatus 4 are identical to each other, both the encryption necessity judging unit 324 can judge that the encrypting operation of the image data is not required, and also can judge that the encrypting operation of the image data is required in any cases other than the first-mentioned case, and the decryption necessity judging unit 422 can judge that the decoding operation of the image data is not required in the first-mentioned case, and also can judge that the decoding operation of the image data is required in any cases other than the first-mentioned case.

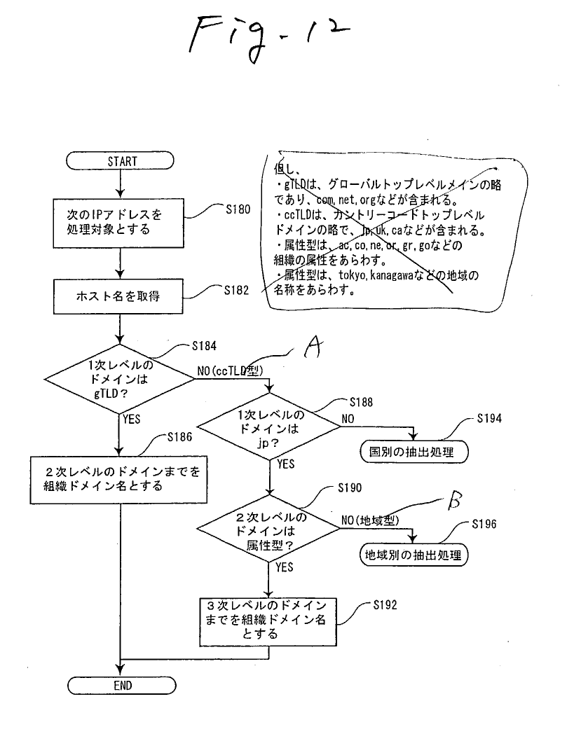

FIG. 11 is a flow chart for describing a process operation (step S20) in which the encryption necessity judging unit 324 (FIG. 4) judges as to whether or not encrypting of image data is required by using an organization domain name.

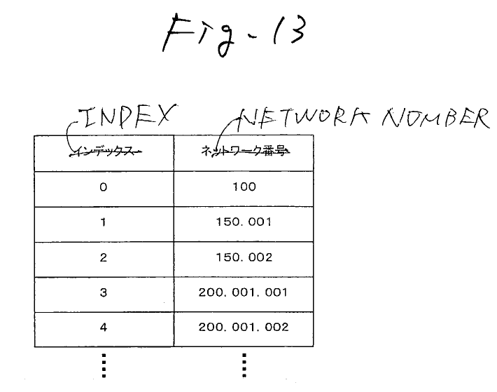

FIG. 12 is a flowchart for explaining a process operation (step S18) in which the encryption necessity judging unit 324 (FIG. 4) acquires an organization domain name from an IP address of a network 2 interposed between the image forming apparatus 3 and the image forming apparatus 4 (FIG. 1 and the like) in the process operations defined in the step S20 shown in FIG. 11.

It should also be noted that in FIG. 12, for the sake of simple and clear explanations, only the ccTLD domain of the jp domain and the regional type domain of the jp domain are exemplified. Apparently, engineers skilled in the art can readily understand that an organization domain name may be extracted from other sorts of domains in a similar manner.

As indicated in FIG. 11, in a step 200 (S200), the encryption necessity judging unit 324 extracts IP addresses of all of networks 2 which are interposed between the image forming apparatus 3 and the image forming apparatus 4.

In a step 18 (S18), as will be described later with reference to FIG. 12, the encryption necessity judging unit 324 extracts an organization domain name of such a next network 2 which has not yet be judged as to whether or not the encrypting operation is required.

In a step 202 (step 202), the encryption necessity judging unit 324 judges as to whether or not organization domain name of the network (next network) 2 which has been finally acquired in the process operation of the step S18 is made coincident with an organization domain name of a network (first network) 2 to which the image forming apparatus 3 belongs.

In the case that these organization domain names are identical to each other, the process operation by the encryption necessity judging unit 324 is advanced to a further step S204, whereas the process operation by the encryption necessity judging unit 324 is advanced to another process operation of a step S208 in any cases other than the first-mentioned case.

In a step 204 (S204), the encryption necessity judging unit 324 judges as to whether or not the encryption necessity judging operations have been accomplished with respect to all of the networks which are interposed between the image forming apparatus 3 and the image forming apparatus 4, and also contain the network 2 (first network) to which the image forming apparatus 3 functioning as the transmission source of the image data belongs, and further contain the network 2 to which the image forming apparatus 4 functioning as the transmission destination of the image data belongs.

In the case that the encryption necessity judging operations are accomplished as to all of the networks, the process operation of the encryption necessity judging unit 324 is advanced to a process operation of a step S206, and is returned to the previous step S18 in any cases other than the first-mentioned case.

In the step 206 (S206), the encryption necessity judging unit 324 judges as to whether or not the encrypting operation for the image data is not required.

In the step 208 (S208), the encryption necessity judging unit 324 judges as to whether or not the encrypting operation for the image data is required.

As shown in FIG. 12, in a step 180 (S180), the encryption necessity judging unit 324 sets an IP address of a next network 2 to be processed in the extracting process operation of the organization domain name.

In a step 182 (S182), the encryption necessity judging unit 324 acquires a domain name corresponding to the IP address of the network 2 which has been set to be processed in the process operation of the step S180 by using the DNS 5 (see FIG. 1).

In a step 184 (S184), the encryption necessity judging unit 324 judges as to whether or not a domain of a primary level is the gTLD (global top-level domain).

In the case that the domain of the primary level is the gTLD, the process operation of the encryption necessity judging unit 324 is advanced to a process operation of a step S186, and is advanced to another process operation of a step S188 in any cases other than the first-mentioned case.

In a step 186 (S186), the encryption necessity judging unit 324 assumes addresses defined up to an address of a secondary level as the organization domain name.

In a step 188 (S188), the encryption necessity judging unit 324 judges as to whether or not a domain of a primary level is the jp domain.

In the case that the domain of the primary level is the jp domain, the process operation of the encryption necessity judging unit 324 is advanced to a process operation of a step S190, and is advanced to another process operation of a step S194 in any cases other than the first-mentioned case.

In a step 190 (S190), the encryption necessity judging unit 324 judges as to whether or not a domain of a secondary level is the attribute type domain.

In the case that the domain of the secondary level is the attribute type domain, the process operation of the encryption necessity judging unit 324 is advanced to a process operation of a step S192, and is advanced to another process operation of a step S196 in any cases other than the first-mentioned case.

In a step 192 (S192), the encryption necessity judging unit 324 assumes domains defined up to a domain of a thirdly level as the organization domain name.

At a step 194 (S194), the encryption necessity judging unit 324 executes the country area extracting process operation.

At the step 194 (S194), the encryption necessity judging unit 324 executes the regional area extracting process operation.

[Method By Employing Table]

As previously explained, in the case that the network-distributed printing operation, it is expectable that the image forming apparatus 3 and the image forming apparatus 4 are combined with each other in the fixing manner so as to transfer the image data, and also, it is expectable that the transfer paths of the image data between these image forming/forming apparatus 3/4 are combined with each other in the fixing manner.

As explained above, such a higher possibility may be expected. That is, any of these networks 2 is interposed between a specific image forming apparatus 3 and a specific image forming apparatus 4. The security aspects of these networks 2 are previously investigated, and thus, the investigated security aspects may be obtained in the form of a table.

In such a case that image data is transferred from the image forming apparatus 3 to the image forming apparatus 4 while referring to the above-described table, the data transfer system of the present invention judges the security aspects of the respective networks 2 interposed between the image forming apparatus 3 and the image forming apparatus 4. In the case that all of these networks 2 are made safe, both the encryption necessity judging unit 324 and the decryption necessity judging unit 422 can judge that both the encrypting operation and the decoding operation are not required. In any cases other than the first-mentioned case, both the encryption necessity judging unit 324 and the decryption necessity judging unit 422 can judge that both the encrypting operation and the decoding operation are required.

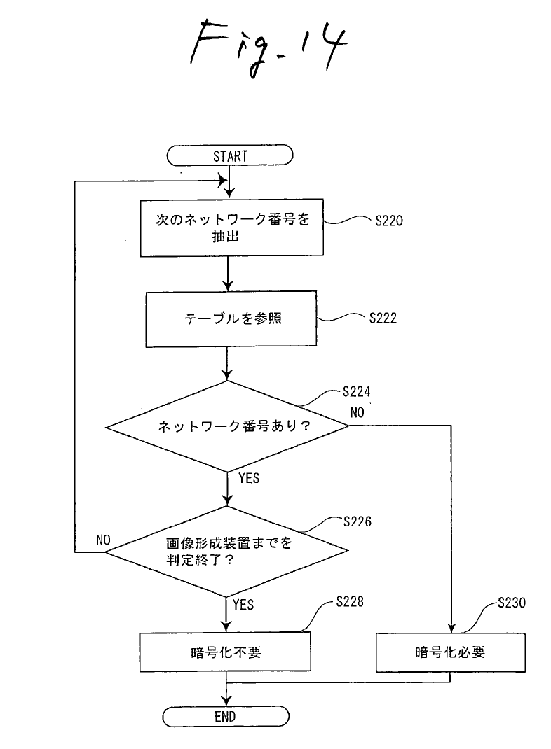

FIG. 13 exemplifies a content of a table which indicates network numbers of such networks 2 through which image data can be transferred in a safe manner among the networks 2 which may be interposed between the image forming apparatus 3 and the image forming apparatus 4 indicated as indexes (0, 1, 2, - - - ).

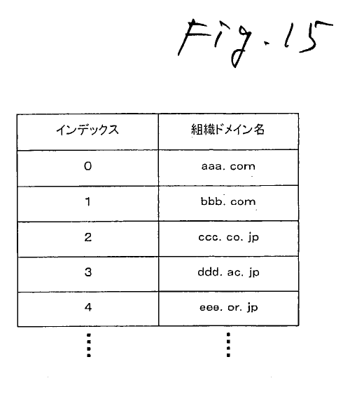

FIG. 14 is a flow chart for explaining a process operation (S22) in which the encryption necessity judging unit 324 (FIG. 4) judges as to whether or not the encrypting operation is required with reference to the table exemplified in FIG. 13.

In a step 220 (S220), the encryption necessity judging unit 324 extracts a network number of such a network 2 which has not yet been judged by the encryption necessity judging unit 324 as to whether or not the encrypting operation is required.

In a step 222 (S222), the encryption necessity judging unit 324 refers to the table exemplified in FIG. 13.

In a step 224 (S224), the encryption necessity judging unit 324 judges as to whether or not the network number extracted by the process operation of the step S220 is made coincident with any one of the network numbers corresponding to the indexes of the image forming apparatus 4 functioning as the transfer destination of the image data in the table checked in the process operation of the step S222.

In the case that there is such a network number coincident with the extracted network number, the process operation of the encryption necessity judging unit 324 is advanced to a process operation of a step S228, and also, is advanced to another process operation of a step S230 in any cases other than the first-mentioned case.

In a step 226 (S226), the encryption necessity judging unit 324 judges as to whether or not the encrypting operations are required with respect to all of the networks 2 present up to the image forming apparatus 4.

In such a case that the judgments as to whether or not the encrypting operations are required have been made with respect to all of the networks 2, the process operation of the encryption necessity judging unit 324 is advanced to a process operation of the step S228, and also, is returned to the previous process operation of the step S220 in any cases other than the first-mentioned case.

In a step 228 (S228), the encryption necessity judging unit 324 judges that the encrypting operation with respect to the image data is not required.

In a step 230 (S230), the encryption necessity judging unit 324 judges that the encrypting operation with respect to the image data is required.

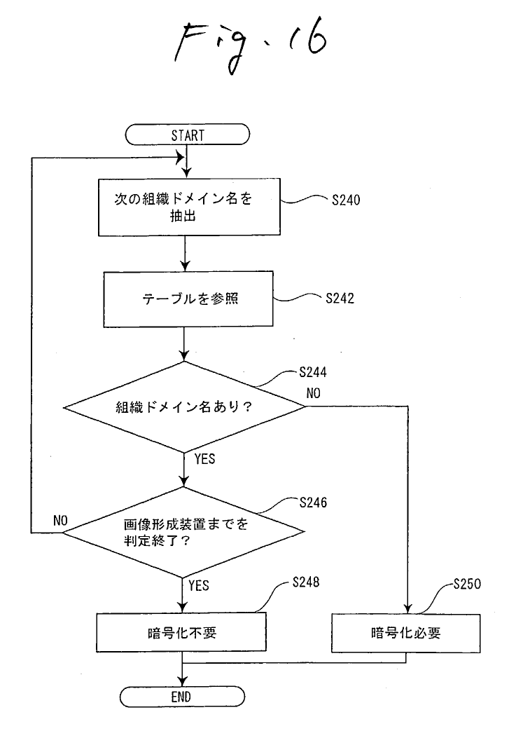

FIG. 15 exemplifies a content of a table which indicates organization domain names of such networks 2 through which image data can be transferred in a safe manner among the networks 2 which may be interposed between the image forming apparatus 3 and the image forming apparatus 4 indicated as indexes (0, 1, 2, - - - ).

FIG. 16 is a flowchart for explaining a process operation (S24) in which the encryption necessity judging unit 324 (FIG. 4) judges as to whether or not the encrypting operation is required with reference to the table exemplified in FIG. 15.

In a step 240 (S240), the encryption necessity judging unit 324 extracts an organization domain name of such a network 2 which has not yet been judged by the encryption necessity judging unit 324 as to whether or not the encrypting operation is required.

In a step 242 (S242), the encryption necessity judging unit 324 refers to the table exemplified in FIG. 15.

In a step 244 (S244), the encryption necessity judging unit 324 judges as to whether or not the organization domain name extracted by the process operation of the step S240 is made coincident with any one of the organization domain names corresponding to the indexes of the image forming apparatus 4 functioning as the transfer destination of the image data in the table checked in the process operation of the step S242.

In the case that there is such an organization domain name coincident with the extracted organization domain name, the process operation of the encryption necessity judging unit 324 is advanced to a process operation of a step S248, and also, is advanced to another process operation of a step S250 in any cases other than the first-mentioned case.

In a step 246 (S246), the encryption necessity judging unit 324 judges as to whether or not the encrypting operations are required with respect to all of the networks 2 present up to the image forming apparatus 4.

In such a case that the judgments as to whether or not the encrypting operations are required have been made with respect to all of the networks 2, the process operation of the encryption necessity judging unit 324 is advanced to a process operation of the step S248, and also, is returned to the previous process operation of the step S240 in any cases other than the first-mentioned case.

In a step 248 (S248), the encryption necessity judging unit 324 judges that the encrypting operation with respect to the image data is not required.

In a step 250 (S250), the encryption necessity judging unit 324 judges that the encrypting operation with respect to the image data is required.

[Overall Operation]

A description will now be made of overall operation of the network system 1 (FIG. 1).

A user manipulates the image forming unit 326 and the like so as to form image data by way of the scanner 182 (FIG. 3) and so on.

While a specific image forming apparatus 4 is designated, the user instructs the image forming apparatus 3 via the input/display apparatus 16 to transmit the formed image data with respect to the designated specific image forming apparatus 4, and also to execute the printing operation by this designated specific image forming apparatus 4.

Upon receipt of this instruction, the UI unit 320 of the image forming/transmission program 32 (FIG. 4) outputs a request for transmitting/printing the image data, and also outputs such an information required for judging as to whether or not the encrypting operation is needed, for example, an IP address of the designated image forming apparatus 4 with respect to both the transmission unit 330 and the encryption necessity judging unit 324.

As explained above, the encryption necessity judging unit 324 judges as to whether or not the encrypting operation for the image data is required, and controls the encrypting unit 328 in response to a judgment result.

The encrypting unit 328 encrypts, or does not encrypt the image data entered from the image forming unit 326 under control of the encryption necessity judging unit 324, and then outputs the resulting image data to the transmission unit 330.

The transmission unit 330 stores either the image data which has been entered from the image forming unit 326 and has been encrypted, or the image data which has been entered from the image forming unit 326 and is not encrypted into the transfer frame 7 shown in FIG. 6. Furthermore, the transmission unit 330 stores the necessary information into the header of the transfer frame 7, and then, transmits the resulting transfer frame 7 via the network 2 with respect to the designated image forming apparatus 4.

In the image forming apparatus 4, the reception unit 4 of the receiving/image forming program 42 (FIG. 5) receives the transfer frame 7 sent from the image forming apparatus 3 in the above-described manner.

The reception unit 420 outputs the information which is contained in the header of the transfer frame 7 and is used to judge as to whether or not the decoding process operation is required with respect to the decryption necessity judging unit 422, and also outputs either the image data which has been encrypted, or the image data which is not encrypted with respect to the decoding unit 424.

The decryption necessity judging unit 422 controls the decoding unit 424 in accordance with a judgment result obtained by judging as to whether or not the decoding operation for the received image data.

Under control by the decryption necessity judging unit 422, this decoding unit 424 decodes the received image data, or outputs the received image data with respect to the receiving/image forming program 428 without being decoded.

The image forming unit 426 controls the print engine 180 (FIG. 3) and the like so as to execute the image forming process operation with respect to such an image data which is entered from the decoding unit 424 and is not encrypted.

As previously explained, both the 5 sorts of encrypting methods and the 5 sorts of methods for judging as to whether or not the decoding operation is required have been exemplified with reference to FIG. 7 to FIG. 16. These methods maybe solely employed, or may be used in the combination manner.

Since plural sets of judging methods among these 5 sorts of methods are combined with each other, the judging subjects which are required to be encrypted/decoded may be expanded, and further, judgment results may be more correctly obtained.

Also, while such an compression/expansion system has been proposed in which image data is compressed by setting a password and the password is entered so as to expand the compressed image data, the data transfer method according to the present invention may employ such a compressing/expanding process operation instead of the above-described encrypting process operation.

Within the encrypting process operations of the above-mentioned descriptions, the general process operations such as this exemplified compression/expansion system are contained by which data cannot be accessed by any persons other than an access-allowed person.

As explained above, the process operation as to the single path has been described. Alternatively, in the case that a plurality of selectable paths are provided, the network system 1 may be arranged in such a manner that judgments are made as to whether or not encrypting operations are required with respect to these plural paths, and thus, such a path where the encrypting operation is not required is selected.

As previously described, in accordance with the data transfer method of the present invention, only the standard encryption algorithm is employed, and furthermore, the throughput of the image transfer operations can be improved without employing the specific hardware designed for the encrypting/decoding operations.

Also, in accordance with the data transfer method of the present invention, since such a throughput can be improved, the time duration (namely, job end time) can be shortened. This time duration is defined by that after the user has instructed the commencement of the original reading operation in the image forming apparatus 3, the print-out operation has been ended in the image forming apparatus.

While the present invention has been described in detail, in accordance with the data transfer system and the data transfer method of the present invention, the data can be transferred in such a manner that the security aspects of the networks interposed between the transmission side and the reception side are judged, and the data encrypting operations are properly carried out.

Also, in accordance with the data transfer system and the data transfer method of the present invention, while the data is transferred via a plurality of networks, the time required to execute the encrypting process operation can be reduced, so that the throughput can be improved.

FIG. 2

3—image forming apparatus;

300—image forming unit;

302—encrypting unit; 2—network; 4—image forming apparatus; 400—decoding unit; 402—image forming unit; A—image data;

FIG. 3

104—memory;

10—control apparatus (PC main body);

180—print engine;

182—scanner;

14—recording apparatus;

FIG. 4

A—from input/display apparatus 16 etc.;

B—from scanner etc.;

C—to communication apparatus 12;

322—transmission control unit;

324—encryption necessity judging unit;

324—image forming unit

328—encrypting unit;

330—transmission unit;

FIG. 5

A—from communication apparatus 12;

B—to print engine 180;

422—decryption necessity judging unit;

424—decoding unit;

426—image forming unit;

FIG. 6

7—transfer frame;

A—header (information for indicating whether or not encrypting operation is required, or file name/attribute);

B—main body of image data (encrypted image data, or not-encrypted image data);

FIG. 7

Steps:

S120—extract IP addresses of all of networks interposed between image forming apparatus and image forming apparatus;

S10—(FIG. 8);

S122—network numbers are identical to each other?;

S124—judgements up to image forming apparatus have been ended?;

S126—encrypting operation is not required;

S128—encrypting operation is required:

FIG. 8

Steps:

S100—set next IP address to be processed;

S102—head 1 bit is “0”?;

S106—head 2 bits are “10”?;

S104—extract IP address bits from head 2 bits up to 7 bits as network number;

S108—extract IP address bits from head 3 bits up to 14 bits as network number;

S104—extract IP address bits from head 4 bits up to 21 bits as network number;

FIG. 9

Steps:

S160—extract IP address; S162 (S14: FIG. 4)—next IP address is private address?;

S164—judgments up to image forming apparatus have been ended?;

S166—judge that encrypting operation is not required;

S168—judge that encrypting operation is required;

FIG. 10

Steps:

S140—set next IP address to be processed; S148—judge IP address as private address; S150—judge IP address not as private address;

S142—IP address is present within range from 10. 0. 0. 0 to 10. 255. 255. 255?;

S144—IP address is present within range from 172. 16. 0. 0 to 172. 31. 255. 255?;

S146—IP address is present within range from 192. 168. 0. 0 to 192. 168. 255.255?;

FIG. 11

Steps:

S200—extract IP addresses of networks located up to image forming apparatus; S18 (FIG. 18)—acquire next organization domain name; S202—organization domain names are identical to each other?; S204—judgements up to image forming apparatus have been ended?; S206—encrypting operation is not required; S208—encrypting operation is required;

FIG. 12

Steps:

S180—set next IP address to be processed; S182—acquire host name; S184—domain of primary level is gTLD domain?;

S188—domain of primary level is jp domain?; S190—domain of secondary level is attribute type domain?;

S186—set domains up to domain of secondary level as organization domain name; S192—set domains up to domain of third level as organization domain name; S194—execute extracting process for country level;

S196—execute extracting process for regional level;

A—NO (ccTLD type); B—NO (regional type);

FIG. 14

Steps:

S220—extract next network number;

S222—refer to table;

S224—network number is present?;

S226—judgments up to image forming apparatus have been ended?;

S228—encrypting operation is not required;

S230—encrypting operation is required;

FIG. 15

A—index;

B—organization domain name;

FIG. 16

Steps:

S240—extract next network number;

S242—refer to table;

S244—organization domain name is present?

S246—judgments up to image forming apparatus have been ended?;

S248—encrypting operation is not required;

S250—encrypting operation is required;

What is claimed is:

1. A data transfer system, comprising:
a data transmission apparatus for transmitting transfer object data; and
a data reception apparatus for receiving the transfer object data via one or more transfer paths;
wherein
the data transmission apparatus includes:
an encryption necessity judging unit for judging whether or not encrypting operation for the transfer object data is necessary on the basis of attributes of the one or more transfer paths,
an encrypting unit for encrypting the transfer object data when the encryption necessity judging unit judges that the encrypting operation for the transfer object data is necessary, and
a data transmitting unit for transmitting either the transfer object data or the encrypted transfer object data via the one or more transfer paths to the data reception apparatus; and
the data reception apparatus includes:
a data receiving unit for receiving either the transfer object data or the encrypted transfer object data from the data transmission apparatus;
a decryption necessity judging unit for judging whether or not decoding operation for the received transfer object data is necessary; and
a decoding unit for decoding the received transfer object data when the decryption necessity judging unit judges that the decoding operation for the received transfer object data is necessary.

2. A data transmission apparatus for transmitting transfer object data via one or more transfer paths, comprising:
an encryption necessity judging unit for judging whether or not encrypting operation for the transfer object data is necessary on the basis of attributes of the one or more transfer paths;
an encrypting unit for encrypting the transfer object data when the encryption necessity judging unit judges that the encrypting operation for the transfer object data is necessary; and
a data transmitting unit for transmitting either the transfer object data or the encrypted transfer object data via the one or more transfer paths.

3. The data transmission apparatus as claimed in claim 2 wherein:
the data transmission apparatus belongs to a predetermined organization; and
the encryption necessity judging unit judges that the encrypting operation for the transfer object data is necessary except when each of the one or more transfer paths belongs to the organization.

4. The data transmission apparatus as claimed in claim 2 wherein:
the data transmission apparatus belongs to a predetermined private network; and
the encryption necessity judging unit judges that the encrypting operation for the transfer object data is necessary except when respective transfer path addresses of all of the one or more transfer paths correspond to private addresses of the private network.

5. The data transmission apparatus as claimed in claim 2 wherein:
the encryption necessity judging unit judges that the encrypting operation for the transfer object data is necessary when at least one of transfer path addresses of each of the one or more transfer path is different from the other and when at least one of domain names of each of the one or more transfer path is different from the other.

6. The data transmission apparatus as claimed in claim 2 wherein:
the encryption necessity judging unit has a table on which either one or both of transfer path addresses and respective domain names thereof are listed, the transfer path addresses belonging to transmission paths between the data transmission apparatus and a predetermined data reception apparatus, the transmission paths capable of safely transmitting the transfer object data; and
the encryption necessity judging unit judges that the encrypting operation for the transfer object data is necessary except when the table indicates either one or both of the transfer path addresses and domain names thereof of all of the one or more transfer paths.

7. An image forming apparatus comprising:
a data transmission apparatus for transmitting transfer object data via one or more transfer paths; and
a image forming unit for forming image data;
wherein
the transfer object data includes the image data;
the data transmission apparatus includes:
an encryption necessity judging unit for judging whether or not encrypting operation for the transfer object data is necessary on the basis of attributes of the one or more transfer paths;
an encrypting unit for encrypting the transfer object data when the encryption necessity judging unit judges that the encrypting operation for the transfer object data is necessary; and
a data transmitting unit for transmitting either the transfer object data or the encrypted transfer object data via the one or more transfer paths.

8. A data reception apparatus for receiving transfer object data via one or more transfer paths, comprising:
a data receiving unit for receiving either the transfer object data or the encrypted transfer object data from the data transmission apparatus;
a decryption necessity judging unit for judging whether or not decoding operation for the received transfer object data is necessary; and
a decoding unit for decoding the received transfer object data when the decryption necessity judging unit judges that the decoding operation for the received transfer object data is necessary.

9. The data reception apparatus as claimed in claim 8,
wherein
the decryption necessity judging unit judges whether or not the received transfer object data is encrypted based upon either one or both of additional information added to the received transfer object data and an attribute value of the transfer object data; and
the decryption necessity judging unit judges that the decoding operation for the received transfer object data is necessary when the transfer object data is judged to be encrypted.

10. An image forming apparatus comprising:
a data reception apparatus for receiving transfer object data via one or more transfer paths; and
a image forming unit for forming image data;
wherein
the data reception apparatus comprises:
a data receiving unit for receiving either the transfer object data or the encrypted transfer object data from the data transmission apparatus;
a decryption necessity judging unit for judging whether or not decoding operation for the received transfer object data is necessary; and
a decoding unit for decoding the received transfer object data when the decryption necessity judging unit judges that the decoding operation for the received transfer object data is necessary.

11. A data transfer method for transferring transfer object data via one or more paths, comprising:
judging whether or not encrypting operation for the transfer object data is necessary on the basis of attributes of the one or more transfer paths;
encrypting the transfer object data when the encrypting operation for the transfer object data is judged to be necessary;
transmitting either the transfer object data or the encrypted transfer object data via the one or more transfer paths;
receiving the transmitted transfer object data;
judging whether or not decoding operation for the received transfer object data is necessary; and
decoding the received transfer object data when the decoding operation for the received transfer object data is judged to be necessary.

12. A data transmission method for transmitting transfer object data via one or more transfer paths, comprising:
judging whether or not encrypting operation for the transfer object data is necessary on the basis of attributes of the one or more transfer paths;
encrypting the transfer object data when the encrypting operation for the transfer object data is judged to be necessary; and
transmitting either the transfer object data or the encrypted transfer object data via the one or more transfer paths.

13. A data reception method for receiving transfer object data via one or more transfer paths, comprising:
receiving the transfer object data;
judging whether or not decoding operation for the received transfer object data is necessary; and
decoding the received transfer object data when the decoding operation for the received transfer object data is judged to be necessary.

14. A recording medium for storing a program to be executed in a data transfer system, wherein the data transfer system includes a data transmission apparatus for transmitting transfer object data and a data reception apparatus for receiving the transfer object data from the data transmission apparatus via one or more transfer paths;
the program causing the data transfer system to execute:
judging in the data transmission apparatus whether or not encrypting operation for the transfer object data is necessary on the basis of attributes of the one or more transfer paths;
encrypting the transfer object data in the data transmission apparatus when the encrypting operation for the transfer object data is judged to be necessary;
transmitting either the transfer object data or the encrypted transfer object data from the data transmission apparatus to the data reception apparatus via the one or more transfer paths;
judging in the data reception apparatus whether or not decoding operation for the received transfer object data is necessary; and
decoding the received transfer object data in the data reception apparatus when the decoding operation for the received transfer object data is judged to be necessary.

15. A recording medium for storing a program to be executed in a data transmission apparatus for transmitting transfer object data via one or more transfer paths, the program causing the data transmission apparatus to execute:
judging whether or not encrypting operation for the transfer object data is necessary on the basis of attributes of the one or more transfer paths;
encrypting the transfer object data when the encrypting operation for the transfer object data is judged to be necessary; and
transmitting either the transfer object data or the encrypted transfer object data via the one or more transfer paths.

16. A recording medium for storing a program to be executed in a data reception apparatus for receiving transfer object data one or more transfer paths, the program causing the data reception apparatus to execute:
receiving the transfer object data;
judging whether or not decoding operation for the received transfer object data is necessary; and
decoding the received transfer object data when the decoding operation for the received transfer object data is judged to be necessary.
